(19) United States
(12) Patent Application Publication
(10) Pub. No.: US 2013/0257018 A1
(43) Pub. Date: Oct. 3, 2013

(54) MOBILE APPARATUS THAT CAN RECOVER FROM TOPPLING

(71) Applicant: Hei Tao Fung, Fremont, CA (US)

(72) Inventor: Hei Tao Fung, Fremont, CA (US)

(21) Appl. No.: 13/847,407

(22) Filed: Mar. 19, 2013

Related U.S. Application Data
(60) Provisional application No. 61/618,844, filed on Apr. 2, 2012.

(51) Int. Cl. B60R 99/00

(52) U.S. Cl. CPC B60R 99/00
USPC 280/638; 29/428

(57) ABSTRACT

We disclose a mobile apparatus that can move steadily in its upright position and can recover from any toppled position to its upright position. The mobile apparatus may find useful applications in various areas such as vehicles, toys, and robots. The mobile apparatus adopts a body shape resembling a sphere with its bottom sliced off. At least three wheels are coupled to the body as ground contacting points to provide the basis of steady movement in its upright position. A weight is coupled to the bottom of the body such that the center of gravity of the mobile apparatus satisfies the following constraints: firstly, the center of gravity is between the bottom of the body and the center of an imaginary sphere that mostly coincides with the body; secondly, the center of gravity falls within the largest imaginary polygon formed by the ground contacting points in the upright position; lastly, the center of gravity falls outside any imaginary polygon formed by the ground contacting points in any toppled position.

### FIELD OF THE INVENTION

The present invention relates to an apparatus that can move around steadily and can recover to an upright position from toppled positions.

### BACKGROUND

A mobile apparatus that has the capability of recovering from toppled positions to an upright position can find useful applications in various areas such as vehicles, toys, and robots. Although there are many ways of achieving that capability, for example, a robot with arms and legs being able to stand back up from the ground with help of its arms and legs, we are looking for a low-cost solution, one that does not involve active components such as servomotors. One solution to provide that capability is using a design likened to a roly-poly toy. In that design, an apparatus has a spherical roller with a weight placed beneath the axis of rotation to provide a gravity-based restoring force sufficient for preventing toppling. An example of such a design is discussed in Xu, et. al., U.S. Patent 2004/0198159. However, that design suffers from a drawback where an initial movement of the apparatus causes swaying because the apparatus of that design has only a single weight-bearing ground contacting point or all weight-bearing ground contacting points located on the same axis of rotation. The drawback is obnoxious for some applications; for example, in the case of a telepresence robot for conducting videoconferencing between a user local to the robot and a remote user controlling the robot, the remote user would find the swaying causing visual annoyance.

### SUMMARY OF THE INVENTION

The object of this invention is a mobile apparatus that can move steadily in its upright position and can recover from any toppled position to its upright position.

Taking advantage of the knowledge of roly-poly toy being able to recover from toppling, we design the apparatus in this invention to use a body in a shape resembling a sphere with its bottom sliced off. In other words, there is an imaginary sphere that mostly coincides with the body, and the imaginary sphere would circumscribe the body. There are at least three wheels coupled to the bottom of the body. The ground contacting points of the wheels form at least three imaginary lines. A weight is coupled to the bottom of the body such that the center of gravity of the mobile apparatus satisfies the following constraints: firstly, the center of gravity is between the bottom of the body and the center of an imaginary sphere that mostly coincides with the body; secondly, the center of gravity falls within the largest imaginary polygon formed by the ground contacting points in the upright position; lastly, the center of gravity falls outside any imaginary polygon formed by the ground contacting points in any toppled position.

The fact that the body is mostly spherical helps easily satisfy the aforementioned constraints on the center of gravity. However, a body with some protruding parts that provide ground contacting points in toppled positions may also do.

The body of the apparatus may be coupled to a head of any shape. The head can be considered as an extension to the body to provide some useful features. However, the combination of the head and the body must satisfy the aforementioned constraints on the center of gravity of the apparatus.

Although the primary goal of this invention is to enable an apparatus to be able to recover from toppling without active components and through gravity-based restoring force alone, there are variation embodiments based on this invention that still use gravity-based storing force but with help of some active components. One example is using a servomotor, as an active component, to shift the center of gravity of the apparatus. Another example is using a servomotor, as an active component, to change the body shape, thereby changing the shape of the imaginary polygon formed by ground contacting points to satisfy the aforementioned constraints on the center of gravity.

### BRIEF DESCRIPTION OF THE DRAWINGS/FIGURES

The present invention will be understood more fully from the detailed description that follows and from the accompanying drawings, which however, should not be taken to limit the disclosed subject matter to the specific embodiments shown, but are for explanation and understanding only.

FIG. 1 illustrates a telepresence robot that makes use of the disclosed invention.

FIG. 2a-2c illustrate the front view, the side view, and the bottom view of an embodiment in its upright position.

FIG. 3a-3c illustrate some toppled positions of an embodiment.

FIG. 4a-4b illustrate the side view and the bottom view of an embodiment that has front wheels and back wheels of different sizes.

FIG. 5a-5b illustrate an embodiment that has a head coupled to a body.

FIG. 6a-6b illustrate how an active component shifts the center of gravity of an embodiment.

### DETAILED DESCRIPTION OF THE INVENTION

The object of this invention is a mobile apparatus that can move steadily in its upright position and can recover from any toppled position to its upright position.

Taking advantage of the knowledge of roly-poly toy being able to recover from toppling, we design the apparatus in this invention to use a body in a shape resembling a sphere with its bottom sliced off. In other words, there is an imaginary sphere that mostly coincides with the body, and the imaginary sphere would circumscribe the body. There are at least three wheels coupled to the bottom of the body. The wheels bear the full weight of the apparatus in its upright position. In other words, the body is spherical except at the bottom part such that the wheels, not the body, would touch the ground in an upright position of the mobile apparatus. The ground contacting points of the wheels are not all on the same imaginary line. They are non-collinear. They should form at least three non-parallel imaginary lines. Those imaginary lines intersect each other and form an imaginary polygon on the ground. There may be many imaginary polygons possibly formed using various combinations of the ground contacting points. Yet, there is one imaginary polygon of the largest area. That largest imaginary polygon is formed using the ground contacting points that maximize the convexity of the imaginary polygon. That largest imaginary polygon represents the area of stability. When the center of gravity of the apparatus falls within the largest imaginary polygon, the apparatus stays upright. There is a weight coupled to the bottom of the body such that the center of gravity of the apparatus is designed to be located near or at the bottom of the body, below the center of the imaginary sphere, and fall perpendicularly within the largest imaginary polygon. The center of gravity does not need to be vertically, with respect to the ground, aligned with the center of the imaginary sphere. The fact that the center of gravity of the apparatus falls perpendicularly within the largest imaginary polygon is the basis of stability in the upright position. Having at least three wheels, that are non-collinear, allows the apparatus to move steadily, without any swaying, in the upright position.

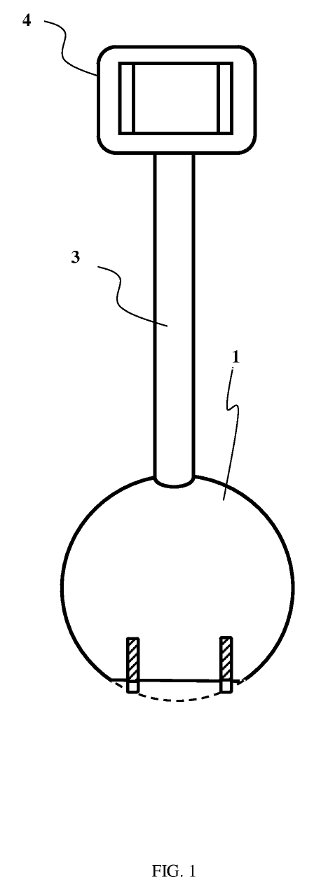

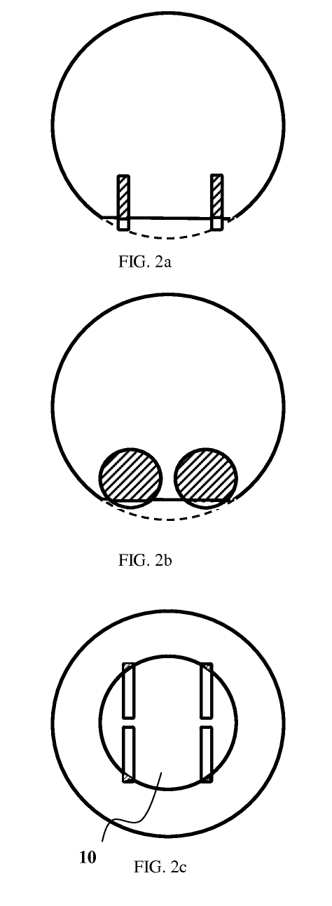

FIG. 1 illustrates a telepresence robot that makes use of the disclosed invention. The telepresence robot has an almost spherical body 1. The body is basically a sphere with the bottom sliced off and with wheels coupled at the bottom. An imaginary sphere would circumscribe the surface of the body 1 and some surface of the wheels. The wheels do not extend beyond the imaginary sphere. The telepresence robot also has a pole 3 that upholds a screen 4. The telepresence robot is shown to be in its upright position in FIG. 1, where only its wheels are ground contacting points. The telepresence robot has four wheels. FIG. 2a is the front view of the body 1. FIG. 2b is the side view of the body 1. FIG. 2c is the bottom view of the body 1. They serve to illustrate that the telepresence robot in its upright position has four ground contacting points and those ground contacting points form an imaginary rectangle. The imaginary rectangle is the area of stability in the upright position.

A weight is coupled to the bottom of the body such that the center of gravity of the mobile apparatus is designed to satisfy the following constraints: firstly, the center of gravity is between the bottom of the body and the center of an imaginary sphere that mostly coincides with the body; secondly, the center of gravity falls within the largest imaginary polygon formed by the ground contacting points in the upright position; lastly, the center of gravity falls outside any imaginary polygon formed by the ground contacting points in any toppled position. In the case of the telepresence robot as in FIG. 1 and FIGS. 2a-2c, the weight may comprise a motor, a battery, and a gear system.

The apparatus may have a number of toppled positions characterized by ground contacting points of the toppled positions. Those ground contacting points may comprise a wheel or wheels and a rounded part of the body. For each toppled position, the ground contacting points of that toppled position form an imaginary polygon. The imaginary polygon may have zero area or non-zero area depending on the locations of the ground contacting points. In the case where there is only one ground contacting point or all ground contacting points are collinear, the imaginary polygon is degenerated, with zero area. To enable the apparatus to recover from any toppled position, the center of gravity of the apparatus must also fall outside the imagery polygon formed from ground contacting points of any toppled position. Then, the weight in the body provides a gravity-based restoring force to put the apparatus back upright.

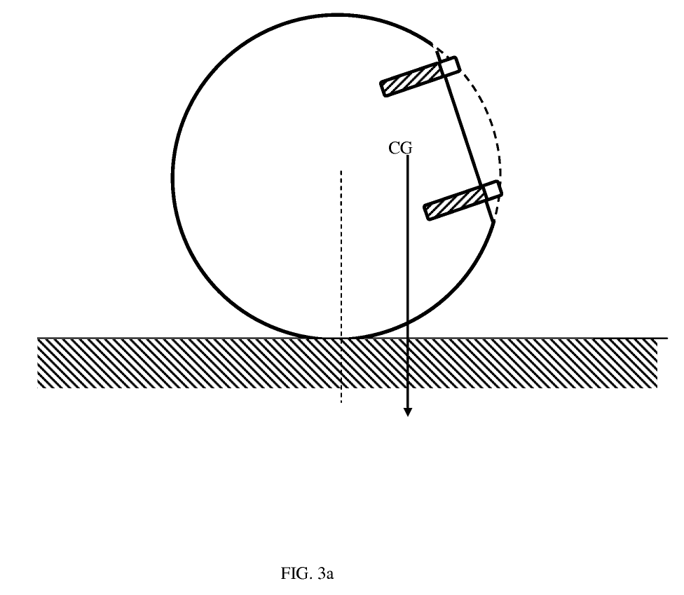

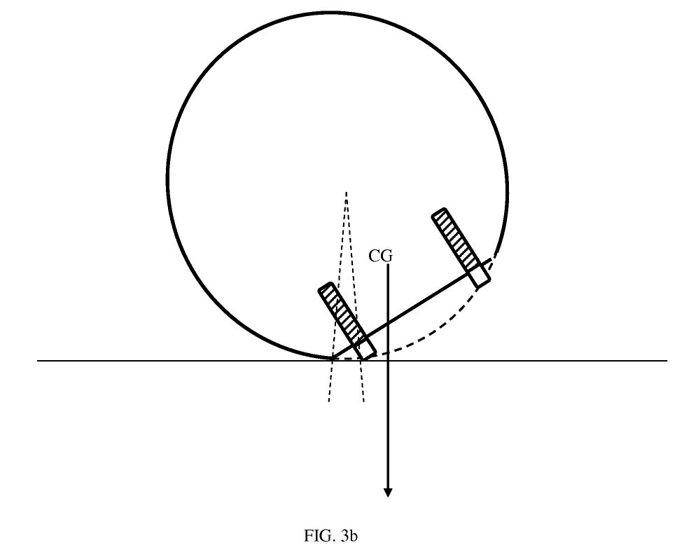

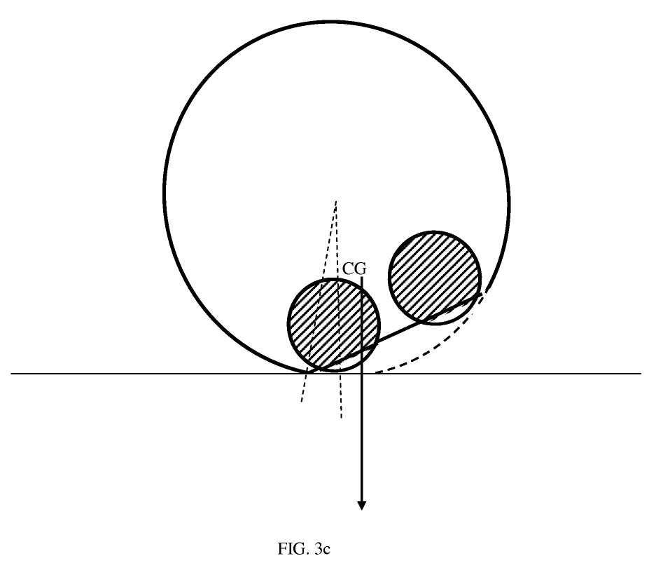

FIGS. 3a-3c illustrate some toppled positions of the telepresence robot of FIG. 1. For illustration purpose, the screen and the pole are ignored. In FIG. 3a, the body is somewhat upside down. There is only one ground contacting point because the body is spherical on most part. The center of gravity (CG) is located near the bottom of the body, and the gravitational force rotates the body about the convex surface back to the upright position. In FIG. 3b, the telepresence robot body is slightly off of its upright position and has three ground contacting points because of a small gap between the rounded part of the body and two of its wheels. The gap is small enough, and the ground contacting points fall on the imaginary sphere circumscribing the body such that the center of gravity falls vertically outside the imaginary triangle formed by the three ground contacting points. The gravitational force rotates the body back to its upright position. In FIG. 3c, it is another viewpoint where the body is slightly off of its upright position. Similarly, the ground contacting points fall on the imaginary sphere circumscribing the body, and the center of gravity falls vertically outside the imaginary triangle formed by the three ground contacting points, a rounded part of the body and two of its wheels. The gravitational force rotates the body back to its upright position.

Sometimes, an imaginary triangle formed by the ground contacting points is degenerated. That happens when there are only one or two ground contacting points or when all ground contacting points are collinear. The aforementioned constraints still apply. The center of gravity should fall outside the degenerated imaginary triangle in any toppled position.

Designing the wheels not to extend beyond the imaginary sphere circumscribing the body helps easily satisfy the aforementioned constraints on the center of gravity. However, the wheels may extend beyond the imaginary sphere as long as the aforementioned constraints on the center of gravity are satisfied. Also, the wheels do not need to be of the same size. Some of the wheels may be driven by motors or free rotating. However, to allow the apparatus to be mobile, at least one of the wheels should be coupled to one or more motor drives. The wheels may take various forms. For example, they can be directional, omni-directional, swivel caster like, etc. Also, the wheels may be partially hidden within the body or completely exposed outside the body. For example, in an embodiment with two back directional wheels, each coupled to a motor drive, and with two front swivel casters, the back directional wheels are partially concealed within the body as their motor drives are completely concealed within the body, while the front swivel casters are connected to the body completely outside. In another embodiment, two wheels are motor-driven, and one wheel that can rotate freely or even does not rotate at all can serve as a balancing ground contacting point. A fake wheel is a wheel that does not rotate or is simply a protruding object, which had better to be smooth, not to produce much friction.

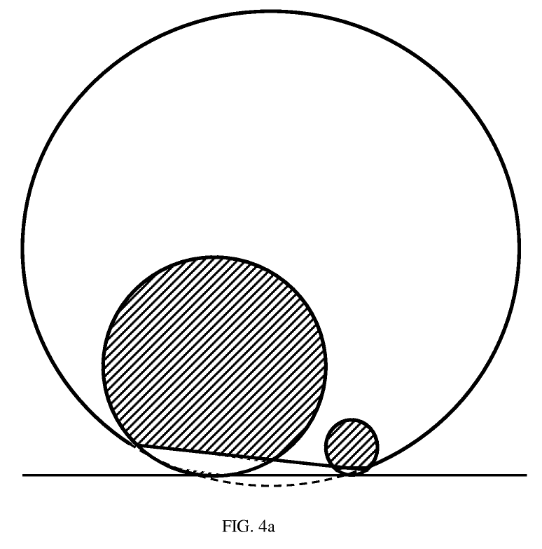

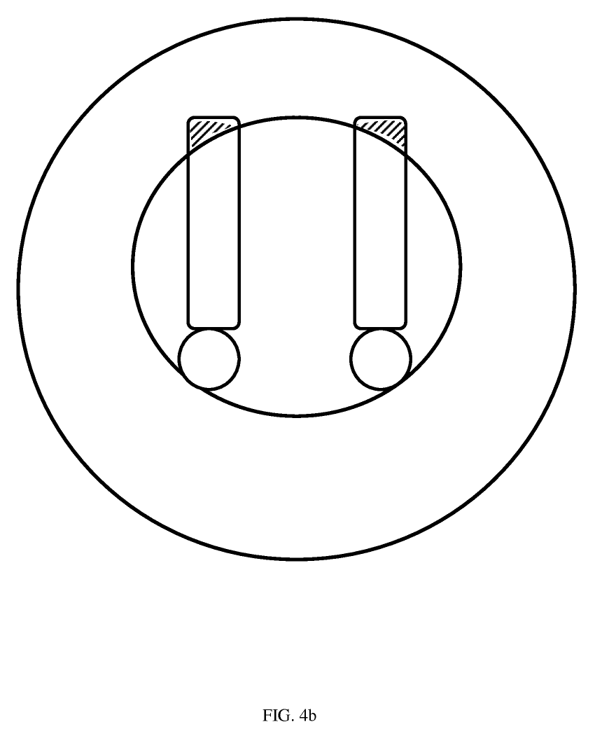

FIGS. 4a and 4b illustrate a telepresence robot body comprising two large back wheels and two small front wheels. FIG. 4a is the side view, and FIG. 4b is the bottom view.

The fact that the body is mostly spherical helps easily satisfy the aforementioned constraints on the center of gravity. However, the body shape does not need to be mostly spherical. A body with convex but non-spherical shape may also do. Similarly, a body with some protruding parts that provide ground contacting points in toppled positions may also do. An example is a body with an urchin shape. Many body shapes may do as long as the aforementioned constraints on the center of gravity with respect to various imaginary polygons of ground contacting points in various toppled positions and in the upright position are satisfied. A spherical body has an important characteristic in that it provides only one ground contacting point on the body in any toppled position. (Note that the wheels are not considered parts of the body.) A body that provides only one ground contacting point in any toppled position tends to help easily satisfy the aforementioned constraints on the center of gravity.

The phrase mostly spherical body shapes should be understood in a broad sense including smooth surface balls, patterned surface balls, ball-shaped skeletal structures, and deformed-ball-shaped structures with parts of the ball that can never touch the ground trimmed.

The bottom of the body does not need to be flat nor parallel to the ground. In fact, when the wheels are of different sizes, it may make sense to use curved or slanted bottom such that the area of any imaginary polygon of ground contacting points of any toppled position is minimized so as to help easily satisfy the aforementioned constraints on the center of gravity. Also the bottom of the body may be physical or imaginary. In other words, there might not be a physical part covering the bottom of the body; in that case, the weight can be coupled to the body through other physical part of the body and still be located near or at the imaginary bottom of the body. However, it does make sense to use a physical bottom; having a physical bottom makes it easy to hold the weight as the weight may comprise at least one motor drive and even a battery system.

The body of the apparatus may be coupled to a head of any shape. The head can be considered as an extension to the body to provide some useful features. For example, in the case of a telepresence robot, the head elevates a screen to a height comfortable to a user local to the robot. The head can bear some weight. However, the combination of the head and the body must satisfy the aforementioned constraints on the center of gravity of the apparatus. Furthermore, although one or more parts of the head may contact the ground in some toppled positions, we impose a constraint that there must be at least one ground contacting point at the body in any toppled position. Then, the effect of the head with respect to the ability of recovering from toppling can be ignored. We differentiate the head from the body because the head has nothing to do with the ability of recovering from toppling while the body does, and the head can provide some useful features to the apparatus suited for certain applications.

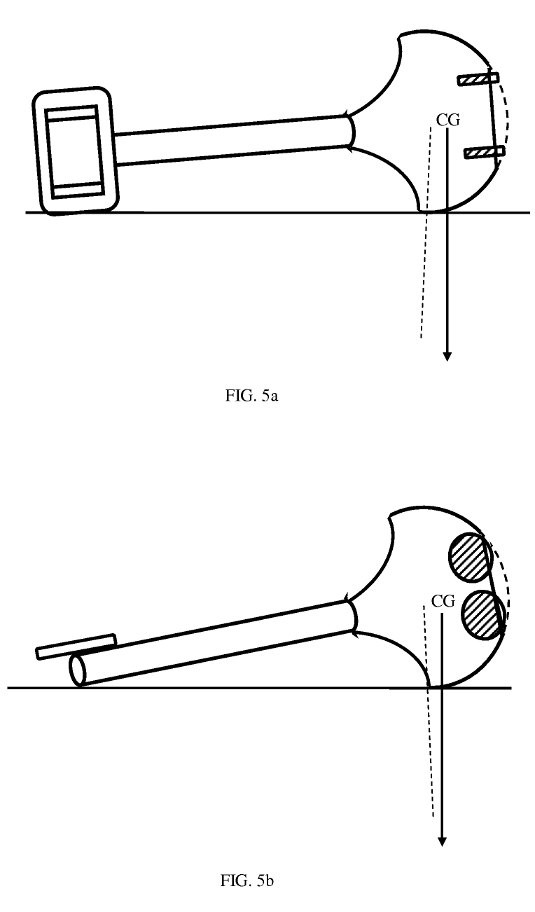

FIGS. 5a and 5b illustrate a telepresence robot with its head elevating a screen. The telepresence robot does not have a spherical body. In fact, the upper part of the body is trimmed for aesthetic, cost, or utility reasons. However, when the telepresence robot is toppled as in FIGS. 5a and 5b, the convex surface of the telepresence robot body that coincides with the imaginary sphere circumscribing the body still serves as one ground contacting point. The overall effect of allowing the gravitational force to restore the telepresence robot to its upright position is still in place. That is to say, the overall shape of the head and body, though not spherical, may still provide the ability of recovering from any toppled position as long as the aforementioned constraints on the center of gravity are met. It is necessary that the body presents a convex surface wherever makes contact to the ground at any toppled position so that the body may roll back to the upright position by gravitational force.

Although the primary goal of this invention is to enable an apparatus to be able to recover from toppling without active components and through gravity-based restoring force alone, there are variation embodiments based on this invention that still use gravity-based storing force but with help of some active components. One example is using a servomotor, as an active component, to shift the center of gravity of the apparatus. The servomotor controls the position of one or more weighty parts and thereby changing the position of the center of gravity to satisfy the aforementioned constraints on the center of gravity. Another example is using a servomotor, as an active component, to change the body shape. The servomotor controls the extension and contraction of a body part to be or not to be a ground contacting point in a toppled position and thereby changing the shape of the imaginary polygon formed by ground contacting points to satisfy the aforementioned constraints on the center of gravity.

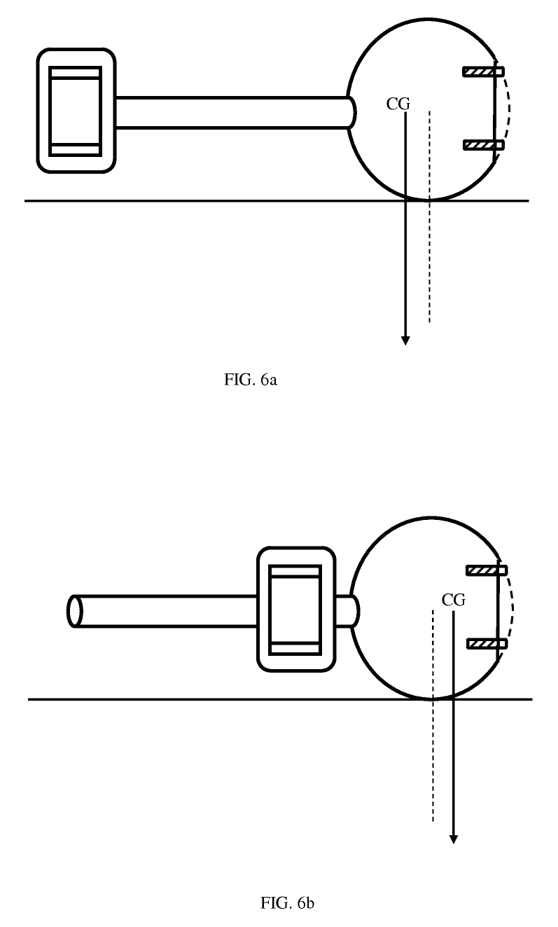

FIG. 6a illustrates a telepresence robot whose center of gravity is above the center of the imaginary sphere circumscribing the body and located on the upper half of the imaginary sphere. In its toppled position shown in FIG. 6a, the telepresence robot is unable to recover to its upright position. Through an active component, the screen of the telepresence robot is moved to a position close to its body, and, therefore, the center of gravity of the telepresence robot is shifted to the bottom half of the imaginary sphere as in FIG. 6b. Now the telepresence robot can recover to its upright position by the gravitational force.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A mobile apparatus that can recover from any toppled position to an upright position, the mobile apparatus comprising:
a body that is mostly spherical;
three or more wheels coupled to the body, wherein the wheels are ground contacting points in the upright position, the ground contacting points in the upright position being non-collinear; and
a weight coupled to the body and located at or near the bottom of the body such that the center of gravity of the mobile apparatus satisfies constraints comprising:
the center of gravity being between the bottom of the body and the center of an imaginary sphere that mostly coincides with the body;
the center of gravity falling within an imaginary polygon formed by some or all of the ground contacting points in the upright position, the imaginary polygon being the largest in area among all imaginary polygons possibly formed by some or all of the ground contacting points in the upright position; and
the center of gravity falling outside any imaginary polygon possibly formed by some or all of ground contacting points of the mobile apparatus in any toppled position.

2. The mobile apparatus as in claim 1, wherein the imaginary polygon possibly formed by some or all of ground contacting points of the mobile apparatus in any toppled position is degenerated.

3. The mobile apparatus as in claim 1, wherein the wheels do not extend beyond the imaginary sphere that mostly coincides with the body.

4. The mobile apparatus as in claim 1, wherein one or more of the wheels are fake.

5. The mobile apparatus as in claim 1, further comprising a head coupled to the body.

6. The mobile apparatus as in claim 1, further comprising an active component that can shift the center of gravity of the mobile apparatus to satisfy the constraints in a toppled position.

7. The mobile apparatus as in claim 1, further comprising an active component that can introduce or remove at least one ground contacting point on the body to satisfy the constraints in a toppled position.

8. A mobile apparatus that can recover from any toppled position to an upright position, the mobile apparatus comprising:
a body that presents a convex surface when in contact with the ground at any toppled position;
three or more wheels coupled to the body, wherein the wheels are ground contacting points in the upright position, the ground contacting points in the upright position being non-collinear; and
a weight coupled to the body and located at or near the bottom of the body such that the center of gravity of the mobile apparatus satisfies constraints comprising:
the center of gravity being at or near the bottom of the body;
the center of gravity falling within an imaginary polygon formed by some or all of the ground contacting points in the upright position, the imaginary polygon being the largest in area among all imaginary polygons possibly formed by some or all of the ground contacting points in the upright position; and
the center of gravity falling outside any imaginary polygon possibly formed by some or all of ground contacting points of the mobile apparatus in any toppled position.

9. The mobile apparatus as in claim 8, wherein the imaginary polygon possibly formed by some or all of ground contacting points of the mobile apparatus in any toppled position is degenerated.

10. The mobile apparatus as in claim 8, wherein one or more of the wheels are fake.

11. The mobile apparatus as in claim 8, further comprising a head coupled to the body.

12. The mobile apparatus as in claim 8, further comprising an active component that can shift the center of gravity of the mobile apparatus to satisfy the constraints in a toppled position.

13. The mobile apparatus as in claim 8, wherein further comprising an active component that can introduce or remove at least one ground contacting point on the body to satisfy the constraints in a toppled position.

14. A method for producing a mobile apparatus that can recover from any toppled position to an upright position, the method comprising:
providing a body that is mostly spherical;
coupling three or more wheels to the bottom of the body, wherein the wheels are ground contacting points in the upright position, the ground contacting points in the upright position being non-collinear; and
coupling a weight at or near the bottom of the body such that the center of gravity of the mobile apparatus satisfies constraints comprising:
the center of gravity being between the bottom of the body and the center of an imaginary sphere that mostly coincides with the body;
the center of gravity falling within an imaginary polygon formed by some or all of the ground contacting points in the upright position, the imaginary polygon being the largest in area among all imaginary polygons possibly formed by some or all of the ground contacting points in the upright position; and
the center of gravity falling outside any imaginary polygon possibly formed by some or all of ground contacting points of the mobile apparatus in any toppled position.

15. The mobile apparatus as in claim 14, wherein the imaginary polygon possibly formed by some or all of ground contacting points of the mobile apparatus in any toppled position is degenerated.

16. The method as in claim 14, wherein the wheels do not extend beyond the imaginary sphere that mostly coincides with the body.

17. The method as in claim 14, wherein one or more of the wheels are fake.

18. The method as in claim 14, further comprising coupling a head to the upper part of the body.

19. The method as in claim 14, further comprising providing an active component that can shift the center of gravity of the mobile apparatus in a toppled position to satisfy the constraints.

20. The method as in claim 14, further comprising providing an active component that can introduce or remove at least one ground contacting point on the body in a toppled position to satisfy the constraints.
